(19) United States
(12) Patent Application Publication
(10) Pub. No.: US 2019/0102796 A1
(43) Pub. Date: Apr. 4, 2019

(54) AUTO MERCHANDISER SYSTEM AND METHOD

(71) Applicant: G. Thomas Sahn, Waterbury, CT (US)

(72) Inventor: G. Thomas Sahn, Waterbury, CT (US)

(21) Appl. No.: 15/730,566

(22) Filed: Oct. 11, 2017

Related U.S. Application Data
(60) Provisional application No. 62/568,190, filed on Oct. 4, 2017.

(51) Int. Cl. G06Q 30/02; G06F 3/0488; G06K 7/14

(52) U.S. Cl. CPC G06Q 30/0257; G06Q 30/0267; G06K 7/1404; G06Q 30/0237; G06F 3/0488; G06Q 30/0277

(57) ABSTRACT

A promotional aid application system includes a portable electronic tablet having a display screen, a processor, a memory, and a communication link being wireless or hardware. The portable electronic is configured to display content received from the communication link on the display screen such that potential buyers are able to be informed of product information.

### CROSS REFERENCE TO RELATED APPLICATION

The present application is related to and claims priority to U.S. Provisional Patent Application No. 62/568,190 filed Oct. 4, 2017 which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of promotions and more specifically relates to a promotional content application.

### 2. Description of Related Art

Advertising is an audio or visual form of marketing communication that employs an openly sponsored, non-personal message to promote and inform consumers of a product, service or idea. Sponsors of advertising are often businesses who wish to promote their products or services. Advertising can target a particular market or group of people. Advertising may be communicated through various mass media, including newspapers, magazines, television, radio, etc.

Currently, the consumer relies on the limited information provided on the product packaging or with store workers. In some cases, store workers may be inconvenient to receive product information from. The customer may go online to search for additional information if it exists. Although, there have been technologies developed to help improve consumer experience in the retail and wholesale space, it has yet to be explored combining the use of motion detection, to acknowledge a consumer presence, and the use of product video to visually illustrate product details, it's use and benefit to the consumer as well as an advertising and informative application to the retail and wholesale space. Therefore, a suitable solution is required.

U.S. Pub. No. 2002/0010655 to Jan Kjallstrom relates to a real time, three-dimensional, configurable, interactive product display system and method. The described real time, three-dimensional, configurable, interactive product display system and method includes a real-time, three-dimensional, interactive, configurable product display system and method. An interactive interface configures and displays products in real-time. The interface comprises a search mechanism that retrieves a product from a data repository according to predefined criteria and a three-dimensional viewer displaying a three-dimensional view of the product. The interface may also include a two-dimensional viewer displaying a two-dimensional view of the product. The two-dimensional view of the product corresponds to the three-dimensional view of the product. Additionally, an interactive method is disclosed for configuring and displaying a product display in real-time. The method comprises the steps of retrieving a product from a data repository in response to input from a user, configuring the product in real-time according to instructions from the user; and displaying a three-dimensional, real-time view of the product.

### BRIEF SUMMARY OF THE INVENTION

In view of the foregoing disadvantages inherent in the known promotions art, the present disclosure provides a novel promotional aid application system. The general purpose of the present disclosure, which will be described subsequently in greater detail, is to provide a real-time promotional aid application to be displayed on a portable tablet for informing potential buyers of product information.

A promotional aid application system is disclosed herein. The promotional aid application system includes a portable electronic tablet including, a housing, a user interface fixed to the housing with a display screen, and a processor embedded in the housing and configured to receive at least one user command via the user interface. A communication link may further be included and communicably coupled to the processor, configured to receive content from a content supplier. A memory may be embedded in the housing and communicably coupled to the processor, and configured to store the content. The processor may be further be configured to communicate with the memory, to execute the at least one user command received via the user interface, and to display the content on the display screen such that the potential buyers are able to be informed of the product information.

A method of using the promotional aid application system is also disclosed herein. The method of using promotional aid application system may comprise the steps of: providing a portable electronic tablet that may include a communication link communicably coupled to a processor, and configured to receive content from a content supplier; activating the content via a motion sensor; displaying the content on a display screen; receiving an information request associated with the content; connecting with the content supplier on the communication link; and purchasing an item associated with the content. The method may further optionally include scanning a universal product code (UPC) with a selection device.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a promotional aid application system, constructed and operative according to the teachings of the present disclosure.

FIG. 1 is a perspective view of the promotional aid application system during an ‘in-use’ condition, according to an embodiment of the disclosure.

FIG. 2 illustrates an example of the portable electronic tablet and network environment that may be used to implement one or more aspects of the disclosure.

FIG. 3 illustrates an example of the portable electronic tablet and network environment that may be used to implement one or more aspects of the disclosure.

FIG. 4 is a flow diagram view of the promotional aid application system of FIG. 1, according to an embodiment of the present disclosure.

FIG. 5 is a flow diagram view of the promotional aid application system of FIG. 1, according to an embodiment of the present disclosure.

FIG. 6 is a flow diagram illustrating a method of use for the promotional aid application system, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to promotions and more particularly to a promotional aid application system as used to improve real-time promotional means.

Generally, the promotional aid application system is ideal for higher priced products in a retail stores or trade shows. The system is an application suitable for a portable electronic tablet compatible with a variety of operating systems. The promotional aid application system may utilize the portable electronic tablet for running a specialized application that can be programmed to deliver both video and text presentation to potential buyers about a specific product. The video may include a demonstration video illustrating the specific product and other beneficial features. Furthermore, the system may include an automatic content display (i.e. pricing, information, promotions, etc.) of the product being advertised.

The portable electronic tablet may allow for the system to be interactive with potential buyers through a conductive display screen. Moreover, it is designed to be implemented as a managed infrastructure, where the system can be managed and monitored remotely. Such an infrastructure may be advantageous in providing statistical analysis of logged events. Integral features understood by those having ordinary skill in the art of electronic tablets (i.e. global positioning system, battery charge, etc.) may be utilized with the present disclosure.

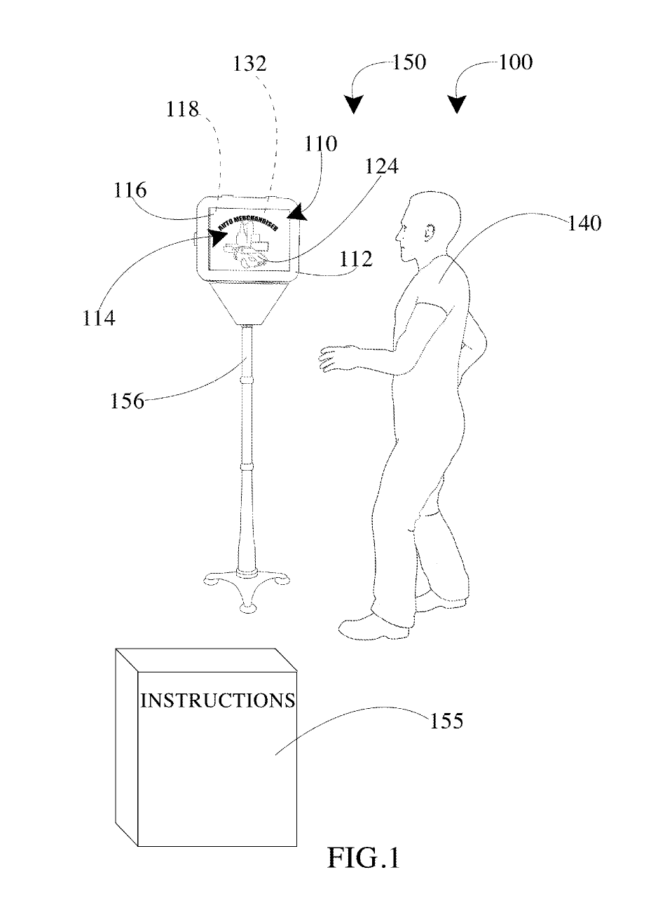

Referring now more specifically to the drawings by numerals of reference, there is shown in FIGS. 1-5, various views of a promotional aid application system 100. FIG. 1 shows a promotional aid application system 100 during an ‘in-use’ condition 150, according to an embodiment of the present disclosure. As illustrated, the promotional aid application system 100 may include a portable electronic tablet 110 including a housing 112, a user interface 114 fixed to the housing 112 which may include a display screen 116. The display screen 116 may be a capacitive touch screen and able to receive the at least one user command 120. Furthermore, a processor 132 may be embedded in the housing 112 and configured to receive at least one user command 120 via the user interface 114. A communication link 122 may be communicably coupled to the processor 132 configured to receive content 124 from a content supplier 126. The content supplier 126 may include companies, vendors, or the like. A memory 118 may be embedded in the housing 112 and communicably coupled to the processor 132, and configured to store the content 124. The processor 132 may be further configured to communicate with the memory 118, to execute the at least one user command 120 received via the user interface 114, and to display the content on the display screen 116 such that a potential buyer 140 is able to be informed of the product information.

The content 124 may be presented by at least one of audio, video, and indicia. The audio, the video, and the indicia may be able to be used in communicative combination in order to inform the potential buyers 140 of the product information. The video may be compatible to a plurality of video formats (i.e. audio video interleave, flash video, moving pictures expert group 4, etc.).

The portable electronic tablet 110 may mountable to a stand 156. The stand 156 may have a height that allows the potential buyers 140 to view and interact with the user interface 114. The stand 156 may be portable and positioned in proximity to a product associated with the content 124. Further, the stand 156 may be configured to prevent theft of the portable electronic tablet 110.

According to one embodiment, the promotional aid application system 100 may be arranged as a kit. The kit may include a set of instructions 155. The instructions may detail functional relationships in relation to the structure of the promotional aid application system 100 (such that the promotional aid application system 100 can be used, maintained, or the like, in a preferred manner).

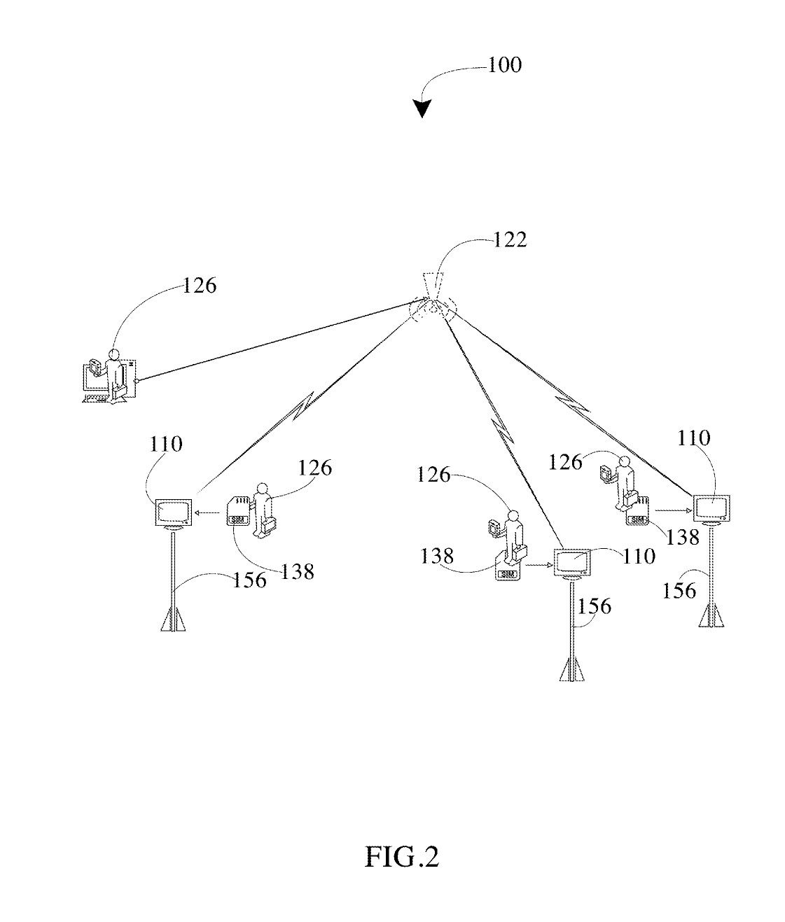

FIG. 2 illustrates an example of the portable electronic tablet 110 and network environment according the promotional aid application system 100 of FIG. 1, according to an embodiment of the present disclosure. As above, the promotional aid application system 100 may include the portable electronic tablet 110 having, the housing 112, and the user interface 114 fixed to the housing 112 which may include the display screen 116. Furthermore, the processor 132 may be embedded in the housing 112, and configured to receive the at least one user command 120 via the user interface 114. The communication link 122 may be communicably coupled to the processor 132, and configured to receive the content 124 from the content supplier 126. The memory 118 may be embedded in the housing 112 and communicably coupled to the processor 132, and configured to store the content 124. The processor 132 may be further configured to communicate with the memory 118, to execute the at least one user command 120 received via the user interface 114, and to display the content 124 on the display screen 116 such that the potential buyers 140 are able to be informed of the product information.

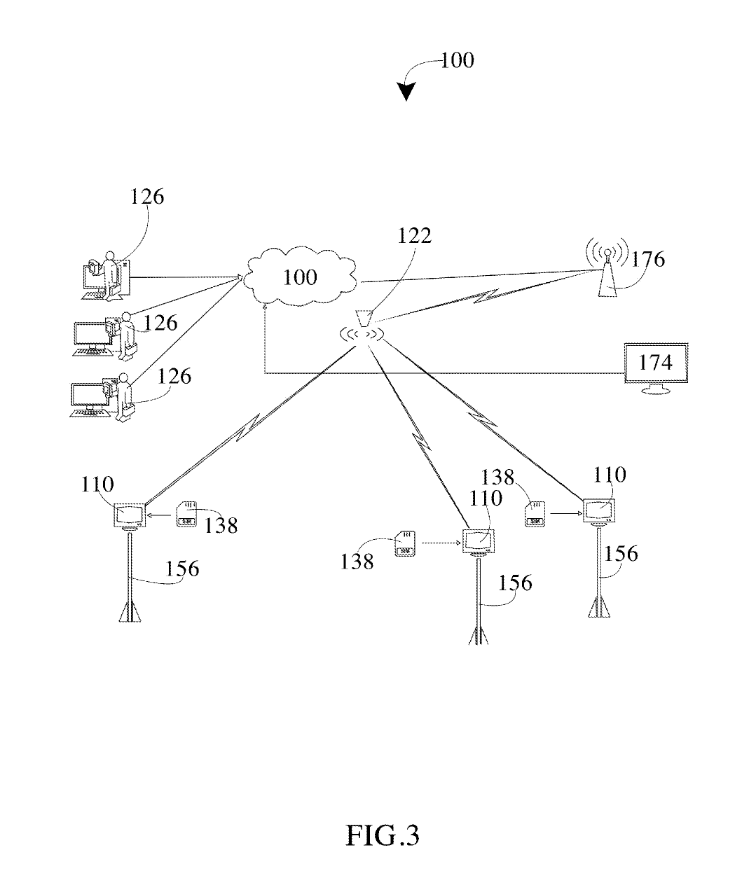

The communication link 122 may be wireless 130. Wireless communication links may include Wi-Fi and a cell tower(s) 176. When utilizing the communication link 122 being wireless 130, the content supplier 126 may upload the content 124 to a cloud storage 172, as illustrated in FIG. 3. The processor 132 of the portable electronic tablet 110 may access the content 124 via the communication link 122 being wireless 130 from the cloud storage 172. Such a network may allow the content 124 to be managed remotely. The content supplier 126 may manage the content 124 remotely via the cloud storage 172.

In another embodiment, the communication link 122 may be hardware 128. The hardware 128 may include but is not limited to a subscriber identification module (SIM) card 138 and a flash drive (not shown). The hardware 128 may enable the content 124 to be uploaded directly to the memory 118. Ports for receiving the subscriber identification module (SIM) card 138 and the flash drive may be integrated to the housing 112 of the portable electronic tablet 110.

FIG. 3 illustrates an example of the portable electronic tablet 110 and network environment that may be used to implement one or more aspects of the disclosure according to an embodiment of the present disclosure. As above, the promotional aid application system 100 may include the communication link 122 which may be communicably coupled to the processor 132 of the portable electronic tablet 110, and configured to receive the content 124 from the content supplier 126. As stated above, the communication link 122 may be wireless 130 or hardware 128. The communication link 122 being wireless 130 may be advantageous in allowing the system 100 to include a remote management 174. The promotional aid application system 100 may be remotely monitored and managed via the cloud storage 172. The content supplier 126 may upload the content 124 to the cloud storage 172 to be remotely monitored.

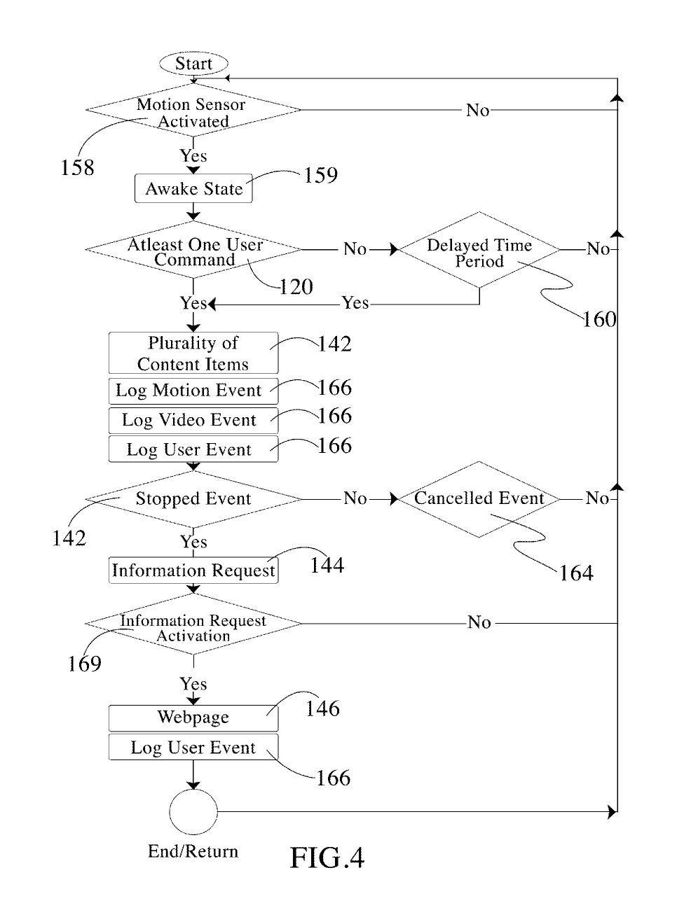

FIG. 4 shows a flow diagram view of the promotional aid application system 100 of FIG. 1, according to an embodiment of the present disclosure. As above, the promotional aid application system 100 may include the portable electronic tablet 110 having the housing 112, and the user interface 114 fixed to the housing 112 which may include the display screen 116. Furthermore, the processor 132 may be embedded in the housing 112, and configured to receive the at least one user command 120 via the user interface 114. The communication link 122 may be communicably coupled to the processor 132, and configured to receive the content 124 from the content supplier 126. The memory 118 may be embedded in the housing 112 and communicably coupled to the processor 132, and configured to store the content 124.

The content 124 may include a plurality of content-items 142 related to the product information. At least one of the plurality of content-items 142 includes discounts. Additionally, at least one of the plurality of content-items 142 may include a demonstration video. The processor 132 may execute the content 124 from the memory 118 to the display screen 116 via a motion sensor 158 affixable to the portable electronic tablet 110. When the potential buyers 140 move within proximity of the portable electronic table 110, the display screen 116 may be activated to an awake state 159. The awake state 159 may include capabilities for the at least one command 120 (i.e. play demonstration video). The plurality of content-items 142 may optionally be activated after a delayed time period 160 to the display screen 116. The at least one user command 120 may include a stopped event 162 to the plurality of content-items 142. The stopped event 162 may allow the potential buyers 140 to activate a cancelled event 164 of at least one of the audio, video, and indicia. A plurality of the logged events 166 (i.e. video, motion, and potential buyer) may be processed to the memory 118 of the portable electronic tablet 110.

The processor 132 may be configured to communicate with the memory 118, to execute the at least one user command 120 received via the user interface 114, and to display the content 124 on the display screen 116. The at least one user command 120 may include an information request 144 associated with at least one of the plurality of content-items 142. An information request activation 168 may be initiated by the potential buyers 140 via the user interface 114 during or after the display of the plurality of content-items 142. The information request 144 may include providing contact information of the potential buyers 140. Further, the information request 144 may launch a Webpage 146 having an associated uniform resource locator (URL). The Webpage 146 may comprise the capability to purchase the product associated with the plurality of content-items 142. Purchases may be obtained through the content supplier 126 and not the promotional aid application system 100.

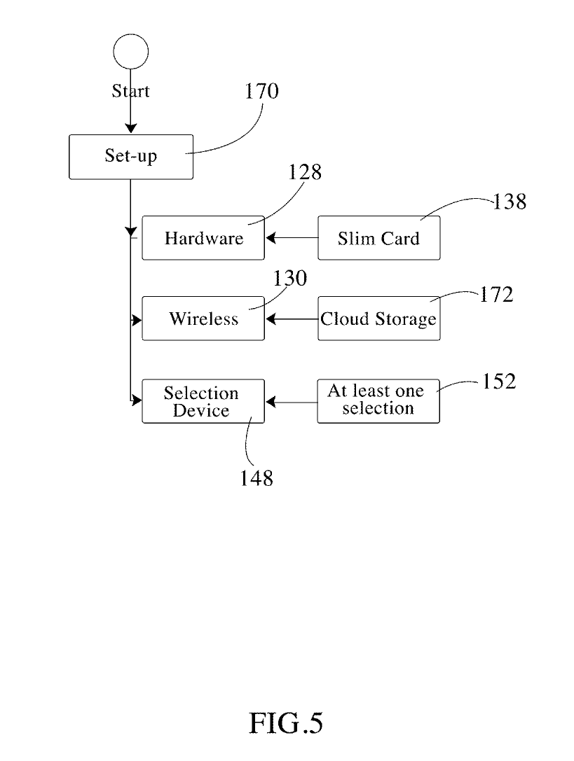

FIG. 5 shows a flow diagram view of the promotional aid application system 100 of FIG. 1, according to an embodiment of the present disclosure. As above, the promotional aid application system 100 may include the portable electronic tablet 110 having the housing 112, and the user interface 114 fixed to the housing 112 which may include the display screen 116. Furthermore, the processor 132 may be embedded in the housing 112, and configured to receive at least one user command 120 via the user interface 114. The communication link 122 may be communicably coupled to the processor 132, and configured to receive the content 124 from the content supplier 126 during a set-up 170 of the content 124. The communication link 122 may comprise the hardware 128 or the wireless 130 connection. The content 124 may optionally be introduced to the processor 132 via a selection device 148 (i.e. bar code scanner). The selection device 148 may be able to receive at least one selection 152 representing the content 124. Further, the selection device 148 may be communicably coupled to the processor 132. The at least one selection 152 may include a universal product code (UPC). The UPC code may be tagged to the content 124 via the communication link 122.

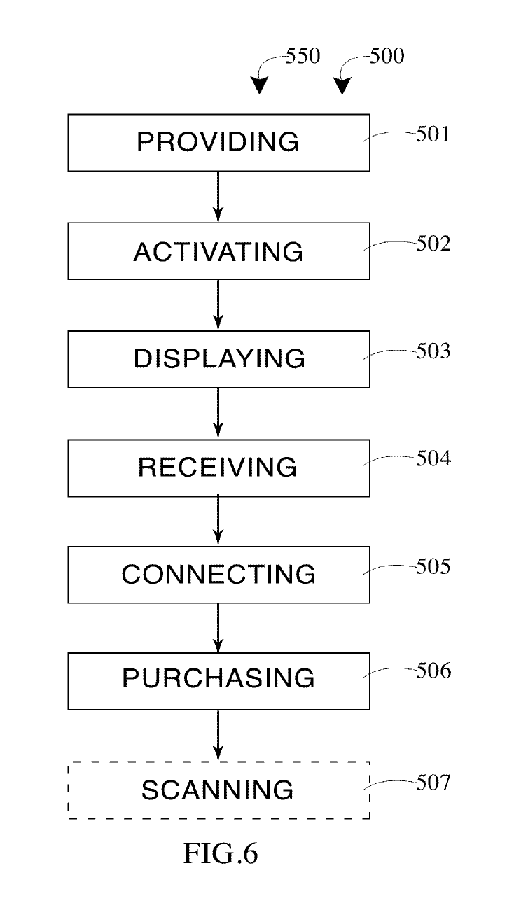

FIG. 6 is a flow diagram 550 illustrating a method of using 500 a promotional aid application system 100, according to an embodiment of the present disclosure. As illustrated, the method of using 500 a promotional aid application system 100 may include the steps of: step one 501, providing the portable electronic tablet that may include the communication link communicably coupled to the processor, and configured to receive content from the content supplier; step two 502, activating the content via the motion sensor; step three 503, displaying the content on the display screen; step 504, receiving the information request associated with the content; step five 505, connecting with the content supplier on the communication link; step six 506, purchasing an item associated with the content; and step seven 507, scanning the universal product code (UPC) with the selection device, the selection device being communicably coupled to the processor.

It should be noted that step 507 is an optional step and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for the promotional aid application system 100 (e.g., different step orders within above-mentioned list, elimination or addition of certain steps, including or excluding certain maintenance steps, etc.), are taught herein. Those with ordinary skill in the art will now appreciate that upon reading this specification and by their understanding the art of the promotional aid application system 100 as described herein, methods of using the promotional aid application system 100 will be understood by those knowledgeable in such art.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A promotional aid application system for informing potential buyers of product information, the promotional aid application system comprising:
a portable electronic tablet including,
a housing,
a user interface fixed to the housing, and including a display screen,
a processor embedded in the housing, and configured to receive at least one user command via the user interface,
a communication link communicably coupled to the processor, and configured to receive content from a content supplier,
a memory embedded in the housing and communicably coupled to the processor, and configured to store the content,
wherein the processor is further configured
to communicate with the memory,
to execute the at least one user command received via the user interface, and
to display the content on the display screen such that said potential buyers are able to be informed of said product information.

2. The promotional aid application system of claim 1, wherein the communication link is wireless.

3. The promotional aid application system of claim 2, wherein the content supplier is managed remotely.

4. The promotional aid application system of claim 1, wherein the communication link uses hardware.

5. The promotional aid application system of claim 4, wherein the hardware is a subscriber identification module (SIM) card.

6. The promotional aid application system of claim 1, wherein the content is presented by at least one of audio, video, and indicia, and wherein said audio, said video, and said indicia are able to be used in communicative combination.

7. The promotional aid application system of claim 1, wherein the content includes a plurality of content-items related to said product information.

8. The promotional aid application system of claim 7, wherein at least one of the plurality of said content-items includes discounts.

9. The promotional aid application system of claim 7, wherein the at least one user command includes an information request associated with at least one of the plurality of said content-items.

10. The promotional aid application system of claim 9, wherein the information request launches a Webpage.

11. The promotional aid application system of claim 10, wherein the Webpage comprises capability to purchase at least one of the plurality of said content items.

12. The promotional aid application system of claim 1, wherein a selection device is able to receive at least one selection representing the content, the selection device being communicably coupled to the processor.

13. The promotional aid application system of claim 12, wherein the at least one selection includes a universal product code (UPC).

14. The promotional aid application system of claim 1, wherein the portable electronic tablet is mountable to a stand.

15. The promotional aid application system of claim 1, wherein the processor executes the content from the memory to the display screen via a motion sensor affixable to the portable electronic tablet.

16. The promotional aid application system of claim 1, wherein the display screen is a capacitive touch screen and able to receive at least one user command.

17. A promotional aid application system, the promotional aid application system comprising:
a portable electronic tablet including;
a housing;
a user interface fixed to the housing, and including a display screen;
a processor embedded in the housing, and configured to receive at least one user command via the user interface;
a communication link communicably coupled to the processor, and configured to receive content from a content supplier; and
a memory embedded in the housing and communicably coupled to the processor, and configured to store the content;
wherein the processor is further configured
to communicate with the memory,
to execute the at least one user command received via the user interface, and
to display the content on the display screen such that said potential buyers are able to be informed of said product information;
wherein the communication link is wireless;
wherein the content supplier is managed remotely;
wherein the content is presented by at least one of audio, video, and indicia, and
wherein said audio, said video, and said indicia are able to be used in communicative combination;
wherein the content includes a plurality of content-items related to said product information;
wherein at least one of the plurality of said content-items includes discounts;
wherein the at least one user command includes an information request associated with at least one of the plurality of said content-items;
wherein the information request launches a webpage;
wherein the webpage comprises capability to purchase at least one of the plurality of said content-items;
wherein a selection device is able to receive at least one selection representing the content, the selection device being communicably coupled to the processor;
wherein the at least one selection includes a universal product code (UPC);
wherein the portable electronic tablet is mountable to a stand;
wherein the processor executes the content from the memory to the display screen via a motion sensor affixable to the portable electronic tablet; and
wherein the display screen is a capacitive touch screen and able to receive at least one user command.

18. The promotional aid application system of claim 17, further comprising set of instructions; and
wherein the system is arranged as a kit.

19. A method of using a promotional aid application system, the method comprising the steps of:
providing a portable electronic tablet including a communication link communicably coupled to a processor, and configured to receive content from a content supplier;
activating the content via a motion sensor;
displaying the content on a display screen;
receiving an information request associated with the content;
connecting with the content supplier on the communication link; and
purchasing an item associated with the content.

20. The method of claim 19, further comprising the steps of
scanning a universal product code (UPC) with a selection device, the selection device being communicably coupled to the processor.
